(19) United States
(12) Patent Application Publication
(10) Pub. No.: US 2026/0195452 A1
(43) Pub. Date: Jul. 9, 2026

(54) BUS TRANSACTION SECURITY IN MULTI-CHIP MODULE

(71) Applicant: Kandou Labs SA, Saint-Sulpice (CH)

(72) Inventor: Peter Korger Korger, Saint-Sulpice (CH)

(73) Assignee: Kandou Labs SA, Saint-Sulpice (CH)

(21) Appl. No.: 19/124,979

(22) PCT Filed: Oct. 27, 2023
(86) PCT No.: PCT/US2023/078015

§ 371 Date: Apr. 28, 2025

Related U.S. Application Data
(60) Provisional application No. 63/381,267, filed on Oct. 27, 2022.

(51) Int. Cl. G06F 21/56; G06F 21/55; G06F 21/85

(52) U.S. Cl. CPC G06F 21/566; G06F 21/554; G06F 21/85

(57) ABSTRACT

A multi-tile retimer is provided that includes a tile-to-tile bus that communicatively couples a leader tile and a follower tile. The multi-tile retimer implements one or more pairs of counters, where each counter in a pair is complementary to the other. Each counter increments based on detection of a particular tile-to-tile bus event, e.g. a read or write command, or data read. The value of one counter in the pair can be compared with the value of the other counter in the pair. A discrepancy in these values can indicate that a security breach may have occurred and/or that a communication error may have occurred on the tile-to-tile bus. Remedial action can be taken in response to such a discrepancy.

### CROSS-REFERENCE TO RELATED APPLICATIONS

This application claims the benefit of U.S. Application No. 63/381,267, filed Oct. 27, 2022, entitled “BUS TRANSACTION SECURITY IN MULTI-TILE RETIMER”, which is hereby incorporated herein by reference in its entirety for all purposes.

### REFERENCES

The following references are herein incorporated by reference in their entirety for all purposes:

PCI Express Base Specification Revision 6.0.1, Version 1.0, Sep. 13, 2022, accessible at pcisig[dot]com/specifications.

PCI Express Retimer Test Specification Revision 4.0, Version 1.0, Jun. 10, 2022, accessible at pcisig[dot]com/specifications.

U.S. application Ser. No. 13/895,206, filed May 15, 2013, which granted as U.S. Pat. No. 9,288,082 on Mar. 15, 2016, entitled “Circuits for Efficient Detection of Vector Signaling Codes for Chip-To-Chip Communication Using Sums of Differences”, naming Roger Ulrich and Peter Hunt (referred to herein as [Ulrich]).

### BACKGROUND

As signals propagate over wires, they tend to degrade—that is, the signal to noise ratio decreases. This attenuation of a signal is often measured in decibels (dB) and tends to increase with the length of the wire that the signal is transmitted over.

Many electronics standards define a maximum loss for signals transmitted between an upstream component and a downstream component. For example, the Peripheral Component Interconnect Express (PCIe) 5.0 standard gives a −36 dB loss budget at 16 GHz for transmission from an upstream component (typically a root complex or switch) to a downstream component (typically an endpoint or switch). Failure to comply with this loss budget results in non-compliance with the standard, which is undesirable. However, it can be difficult to meet a loss budget in practice, particularly in the case of longer wires and higher data rates.

To resolve this issue, a retimer can be used. A retimer is a component that is located in the signal path between the upstream component and the downstream component. The retimer breaks the link between the upstream component and downstream component into two entirely separate links. The retimer is configured to condition the signal it receives via an upstream pseudo-port before transmitting the conditioned signal out via a downstream pseudo-port. Typically, a retimer equalizes the incoming signal and recovers the clocking of the incoming signal, such that the output of the retimer is a high amplitude, low noise and low jitter signal. A retimer can thus significantly reduce the total losses between the upstream and downstream components, bringing a previously non-compliant link within specification.

### BRIEF DESCRIPTION

A retimer can be implemented as a multi-chip module (MCM) in which multiple dies are present on a single substrate. Each die is interchangeably referred to as a ‘tile’ herein. A retimer implemented as a MCM is referred to herein as a ‘multi-tile retimer’.

It is advantageous to be able to communicate between tiles in a multi-tile retimer and a tile-to-tile (‘T2T’) bus is provided for this purpose. In order for the T2T bus to support communication between tiles, it is necessary for wires of the T2T bus to cross between each tile, i.e. to extend outside of the package of each tile. This relatively exposed region of the T2T bus wiring can be accessed physically by a third party with relative ease compared with the interior of a tile which is protected by its package. A hacker or other such nefarious party may thus attempt to physically interface with the wires of the T2T bus at a point between tiles to inject signals in an attempt to disrupt the normal operation of a multi-tile retimer.

Additionally, a multi-tile configuration is somewhat more complex to operate. This is because a processor the multi-tile retimer has to communicate with components located on a different tile than the processor. A tile-to-tile bus (T2T bus) is provided for this purpose. However, due to the cross-tile nature of this bus, the processor may not be able to easily detect errors in the T2T bus that could disrupt operation of the retimer.

A multi-tile retimer is provided that includes a tile-to-tile bus that communicatively couples a leader tile and one or more follower tiles. The multi-tile retimer implements one or more pairs of counters, where each counter in a pair is complementary to the other. Each counter increments based on detection of a particular tile-to-tile bus event, e.g. a read or write command, or data read. The value of one counter in the pair can be compared with the value of the other counter in the pair. A discrepancy in these values can indicate that a security breach may have occurred and/or that a communication error may have occurred on the tile-to-tile bus. Remedial action can be taken in response to such a discrepancy.

In a first aspect, this disclosure describes a method, comprising: reading a first count value stored in a first counter of a multi-tile retimer, the first counter located on a leader tile of the multi-tile retimer and configured to be incremented responsive to a first type of tile-to-tile bus event detected at a bus leader of a tile-to-tile bus coupled between the leader tile of the multi-tile retimer and a follower tile of the multi-tile retimer; reading a second count value stored in a second counter of the multi-tile retimer, the second counter located on a follower tile of the multi-tile retimer and configured to be incremented responsive to the first type of tile-to-tile bus event detected at a bus follower of the tile-to-tile bus; generating a coherency value by comparing the first count value and the second count value; determining a coherency status in response to the coherency value; and selectively taking remedial action based on the coherency value.

In a second aspect, this disclosure describes a multi-tile retimer, comprising: a first counter located on a leader tile of the multi-tile retimer and coupled to a bus leader of a tile-to-tile bus located on the leader tile, the first counter configured to increment a first count value stored by the first counter responsive to a first type of tile-to-tile bus event of the tile-to-tile bus detected at the bus leader, the tile-to-tile bus coupled between the leader tile and a follower tile of the multi-tile retimer; a second counter located on the follower tile and coupled to a bus follower of the tile-to-tile bus, the second counter configured to increment a second count value stored by the second counter responsive to the first type of tile-to-tile bus event of the tile-to-tile bus detected at the bus follower; and a central processing unit located on the leader tile and configured to: generate a coherency value by comparing the first count value and the second count value; determine a coherency status based on the coherency value; and selectively take remedial action based on the coherency value.

### BRIEF DESCRIPTION OF FIGURES

FIG. 1 is a block diagram of a retimer suitable for implementing embodiments described herein.

FIG. 2 is a block diagram of a leader tile of a multi-tile retimer suitable for implementing embodiments described herein.

FIG. 3 is a block diagram of a two-tile retimer suitable for implementing embodiments described herein.

FIG. 4 is a block diagram of the follower tile of the two-tile retimer of FIG. 3.

FIG. 5 is a block diagram of a four-tile retimer suitable for implementing embodiments described herein.

FIG. 6 is a block diagram of a tile-to-tile SPI bus of a two-tile retimer suitable for implementing embodiments described herein.

FIG. 7A is a block diagram of a tile-to-tile SPI bus of a four-tile retimer suitable for implementing embodiments described herein.

FIG. 7B is a block diagram of another tile-to-tile SPI bus of a four-tile retimer suitable for implementing embodiments described herein.

FIG. 8 is a flowchart showing a method according to an embodiment.

### DETAILED DESCRIPTION

At times in this specification reference is made to the Peripheral Component Interconnect Express (PCIe) standard. This is to assist in the understanding of this disclosure by describing certain features in the context of a particular standard. However, it should be appreciated that, unless expressly stated otherwise, teaching herein has applicability outside of the PCIe standard.

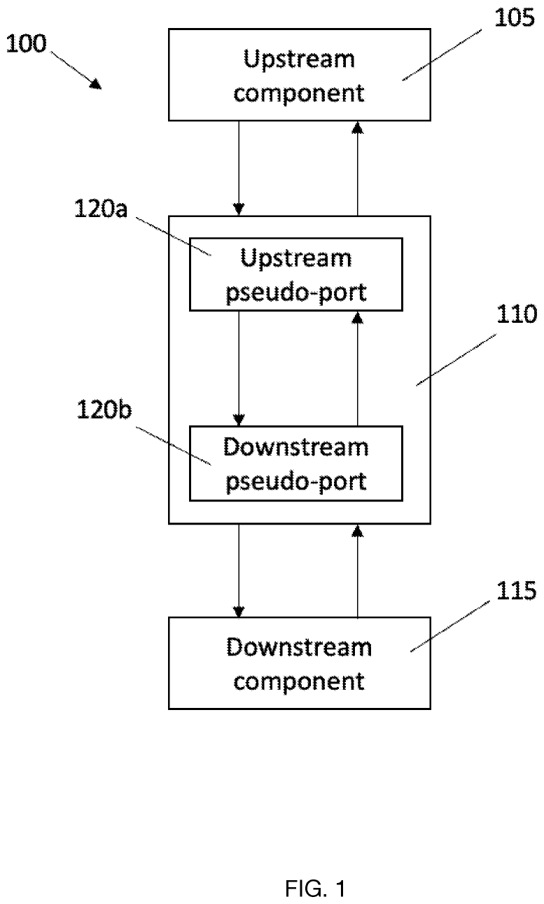

FIG. 1 shows in schematic form a system 100 incorporating a multi-tile retimer 110. Retimer 110 is coupled to an upstream component 105 that is typically a root complex or a switch. This coupling is via upstream pseudo-port 120a of retimer 110. Similarly, retimer 110 is coupled via downstream pseudo-port 120b to a downstream component 115, typically a switch or endpoint. In this disclosure, physical layer entities such as pseudo-ports and serializer/deserializers (SerDes) may be alternatively referred to as PHYs.

It is thus apparent from FIG. 1 that retimer 110 functions to divide a link between upstream component 105 and downstream component 115 into two parts. Retimer 110 is configured to condition the signal received via upstream pseudo-port 120a and to provide a clean signal with low jitter and good signal to noise ratio as an output of downstream pseudo-port 120b. Retimer 110 is bi-directional, and thus is also capable of conditioning a signal received as an input to downstream pseudo-port 120b. In this case, the clean output signal would be sent out via upstream pseudo-port 120a.

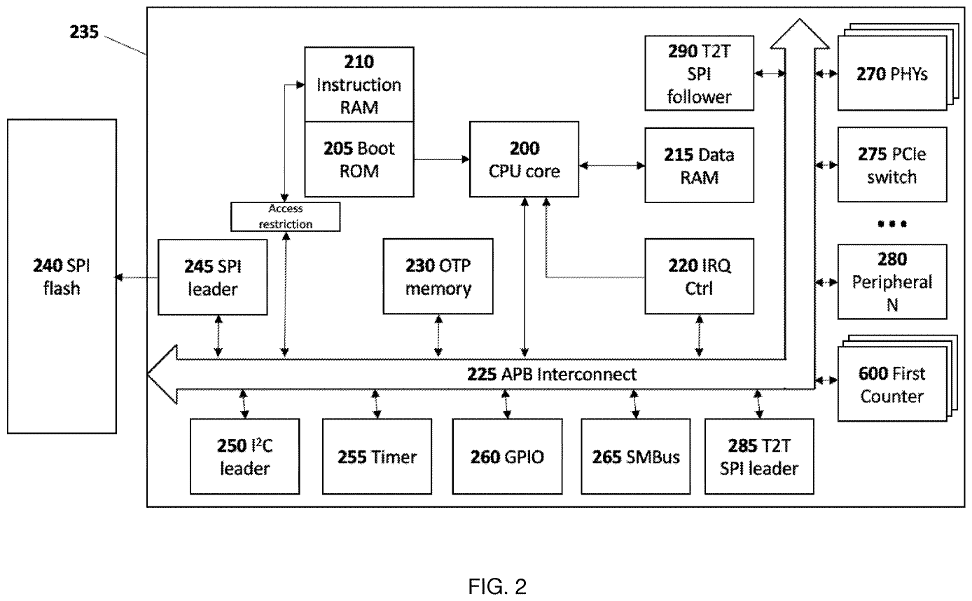

FIG. 2 shows a leader tile of a multi-tile retimer 110 in schematic form in additional detail. For ease of understanding, some components of retimer 110 have been omitted.

Retimer 110 includes a CPU core 200, also referred to herein as a processor. CPU core 200 is configured to perform various tasks to support the function of retimer 110. One such task is the loading of firmware from external non-volatile memory to boot ROM 205 during a boot process. CPU core 200 acts in accordance with instructions stored in instruction RAM 210 and operates on data stored in data RAM 215. CPU core 200 is also coupled to interrupt request (IRQ) controller 220 to enable CPU core 200 to receive interrupt requests from other components of retimer 100 or from external components, and to raise interrupts with external components (e.g. a host CPU).

CPU core 200 is also coupled to Advanced Peripheral Bus (APB) interconnect 225. The APB interconnect 225 enables CPU core 200 to communicate with other components of retimer 110 that are coupled to this bus—reference is made to FIG. 2 in this connection. It will be appreciated that APB interconnection 225 can be replaced with an alternative bus, e.g. AHB, without departing from the scope of this disclosure.

APB interconnect 225 also enables other components of retimer 110 to communicate with instruction ram 210 directly in a controlled manner (see ‘access restriction’ in FIG. 2). This ensures that only components that should be able to access instruction ram 210 can do so, and further that instructions that any such components place in instruction ram 210 are legitimate.

Retimer 110 also includes a non-volatile read-only memory that could be a one-time programmable (OTP) memory 230 as shown in FIG. 2. Other forms of non-volatile ROM could alternatively be used. OTP memory 230 stores, among other things, a public key, or hash of a public key, that is usable by CPU core 200 to check that firmware is genuine as it is loaded by CPU core 200.

Firmware is loaded from an external non-volatile memory. Here, ‘external’ refers to the memory being located off-die, i.e. it is not part of the die 235 that CPU core 200 is part of. In the illustrated embodiment the external non-volatile memory is a SPI flash memory 240. CPU core 200 communicates with SPI flash 240 via an SPI bus, with the corresponding SPI leader 245 being connected to APB interconnect 225 to provide the complete communication channel between CPU core 200 and SPI flash 240. This configuration is provided as an example and is not the only possible configuration. For example, external non-volatile memory could instead be an EEPROM and in that case CPU core 200 could communicate with the EEPROM via and I²C bus (see 12° C. bus leader 250 in FIG. 2) that is coupled to APB interconnect 225. Further variations are possible, and it should be understood that any variation that enables CPU core 200 to communicate with external non-volatile memory is within the scope of this disclosure.

SPI flash 240 stores a firmware image that enables CPU core 200 to boot and to operate retimer 110. The firmware image can include configuration information and other data such as firmware for other components of retimer 110.

It is noted that the PCIe standard as applicable to retimers requires an I²C bus to be present. However, it has been recognised that I²C is a relatively slow interface such that problems can arise when loading firmware from the external memory. Specifically, an I²C bus and EEPROM may make it difficult to meet certain timing requirements of the PCIe specification. For this reason, a SPI bus and SPI flash 240 can be used to significantly reduce firmware loading times by virtue of the fact that an SPI interface offers a higher data transfer rate than an I²C interface. Given this, it is contemplated that in some implementations the I²C bus could be omitted entirely.

Retimer 110 also includes timer 255, general purpose input/output pin(s) (GPIO) 260 and system management bus (SMBus) 265. These components are all coupled to APB interconnect 225 to facilitate communication with other components of retimer 110.

Timer 255 provides a programmable timing capability, e.g. to allow the performance of periodic tasks between which a low power state may be entered. GPIO 260 provides one or more general purpose pins that are unused by default, but which may be controlled by software to be used in some manner, e.g. to extend the functionality of retimer 110 in some way. SMBus 265 provides a facility for communicating information (e.g. status, configuration, device name, type, etc.) about devices coupled to retimer 110 and also for transmitting commands to said devices. One or more of timer 255, GPIO 260 and SMBus 265 could be omitted, or replaced with another component of similar functionality, without departing from the scope of this disclosure.

Retimer 110 further includes one or more physical layer components (PHYs) 270. These each represent physical-layer components, e.g. a serializer/deserializer (SerDes). PHYs 270 are coupled to APB interconnect 225 to provide a communication path to CPU core 200, as well as any other component of retimer 110 also coupled to APB interconnect 225. One or more PHYS 270 may require CPU core 200 to initialise them, e.g. by providing firmware. This could be loaded by CPU core 200 from SPI flash 240, for example.

Retimer 110 additionally includes a PCIe switch 275 that is coupled to APB interconnect 225. PCIe switch 275 implements PCIe switching functionality as defined by the relevant part of the PCIe standard. This enables retimer 110 to operate in a PCIe switching mode if desired. It will be appreciated that PCIe switch 275 can be omitted in the case where it is not necessary for retimer 110 to provide a PCle switching capability.

FIG. 2 includes a placeholder ‘peripheral N’ 280 that is coupled to APB interconnect 225 to illustrate that retimer 110 is not limited to the specific set of peripherals illustrated in FIG. 2. Additional peripherals coupled to APB interconnect 225 may be added to retimer 110 as desired. Examples include: one or more PCIe Compute Express Links (CXLs), Physical Coding Sublayer (PCS) components, a packet inspecting component, a Joint Test Action Group (JTAG) interface, and/or a high-speed die-to-die interface as described in [Ulrich].

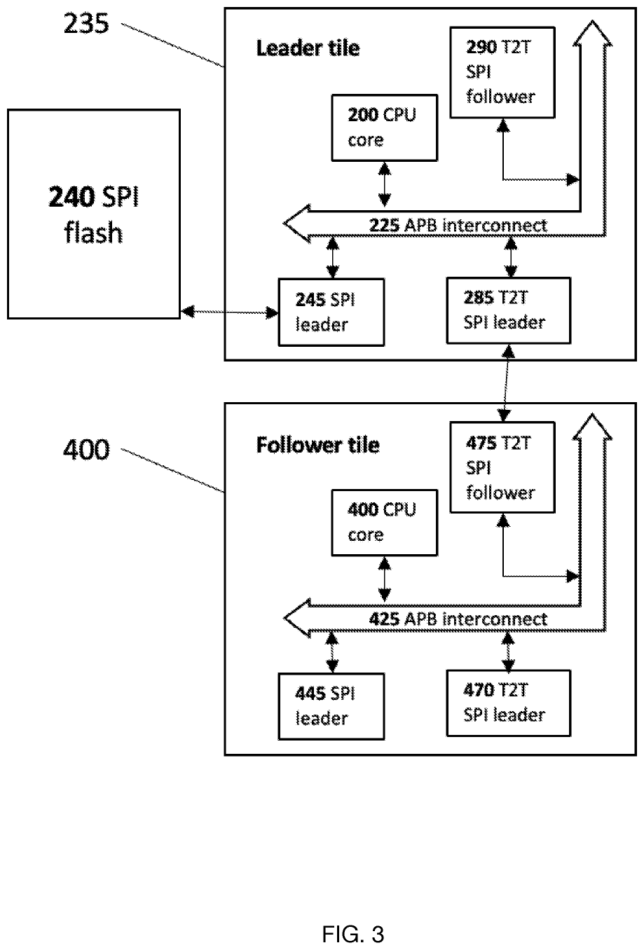

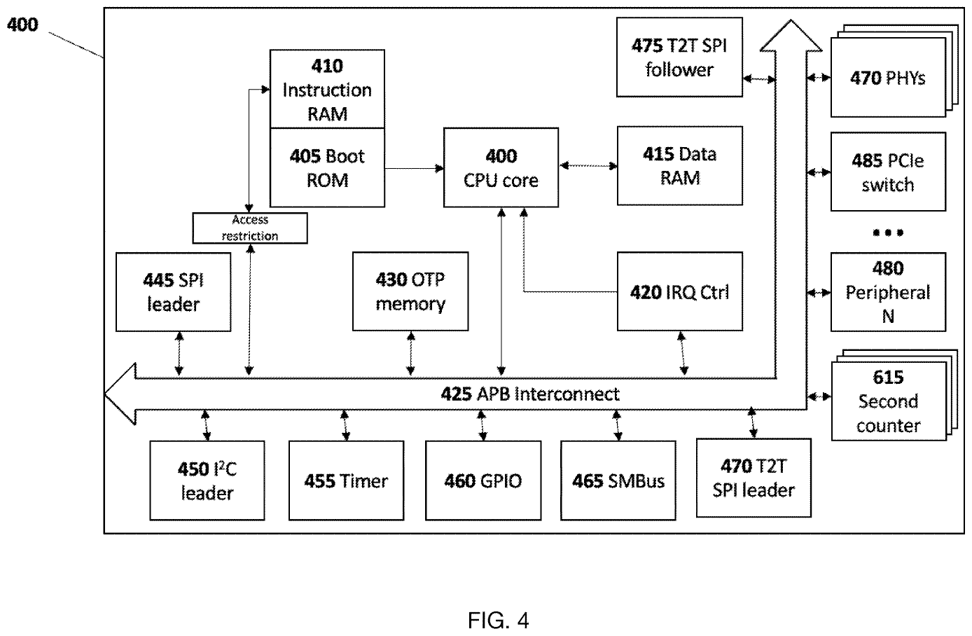

FIG. 2 shows a first counter 600 that is coupled to APB interconnect 225. The first counter can be a read command counter or a write command counter. First counter 600 stores a first count value corresponding to a particular type of tile-to-tile bus event. Additional details of this are provided later in this disclosure. Further counters can also be present on the leader tile as shown in FIG. 2, with each of the further counters also being coupled to APB interconnect 225. FIGS. 3 and 4 show multi-tile retimer 110 embodied as a two-tile retimer. The components of the second tile are located on a separate, second die 400. As shown in FIG. 4, the components of the second tile are largely identical to those of the first tile and have been given reference signs with identical suffix to those of FIG. 2 to reflect this. Reference is thus made to the preceding discussion in this regard.

FIG. 4 shows a second counter 615 that is coupled to APB interconnect 425. Second counter 615 is complementary to first counter 600 as described later in this specification. The second counter can be a read command counter or a write command counter. Second counter 615 stores a second count value corresponding to a particular type of tile-to-tile bus event. Additional details of this are provided later in this disclosure. Further counters can also be present on the follower tile as shown in FIG. 4, with each of the further counters also being coupled to APB interconnect 425.

The first tile is referred to herein as the leader tile (a.k.a. master tile) and the second tile is referred to herein as the follower tile (a.k.a. slave tile). A distinction between the leader tile and follower tile in many embodiments is that the majority of the components on the follower tile are inactive—i.e. either off entirely, or in a low power state. Specifically, in one embodiment, the following components are inactive on the follower tile: CPU core 400, boot ROM 405, instruction RAM 410, data RAM 414, IRQ controller 420, OTP memory 430, SPI leader 445, I²C leader 440, timer 445, GPIO 460, SMBus 465 and T2T SPI leader 475. These components are present as it is easier from a manufacturing perspective to produce identical tiles and designate one as leader and the other as follower. However, alternatively the above-mentioned components could be omitted. Further, during die testing, certain die defects that affect leader tile functions/circuits might nonetheless be deemed acceptable for a die to act as a follower tile, thus increasing production yield percentages.

It is also pointed out that there is no SPI flash (or other external memory) coupled to the follower tile. This is because only the leader tile CPU core 200 is active, hence there is no need to load firmware to inactive CPU core 400 of the follower tile.

The leader tile and follower tile communicate via a tile-to-tile (‘T2T’) bus that spans both dies 235 and 400 (see FIG. 3). In the case of FIGS. 3 and 4 the T2T bus is a SPI bus, but alternative bus types could be used in place of an SPI bus if desired.

To facilitate communication, the leader tile includes a T2T SPI bus leader 285 and the follower tile includes a T2T SPI bus follower 475. The T2T SPI bus leader 285 is coupled to the T2T SPI bus follower 475 via wires extending between the leader and follower tiles. These wires could be circuit traces, for example. As shown in FIG. 3, the wires extend beyond the die/tile boundary and cross the substrate itself.

T2T SPI leader 285 is coupled to APB interconnect 225 on the leader tile to enable communication with other components on the leader tile. Similarly, T2T SPI follower 475 is coupled to APB interconnect 425 on the follower tile to enable communication with other components on the follower tile—most notably, PHYs 470, PCIe switch 485 and other peripherals 480. T2T SPI follower 475 is leader on APB interconnect 425 to enable T2T SPI follower 475 to have full access to all registers on the follower tile.

Remaining true to the principle of identical tiles, in FIGS. 3 and 4 both the T2T SPI leader 470 and T2T SPI follower 475 are shown on the follower tile. However, it should be appreciated that only T2T SPI follower 475 is active on the follower tile of FIG. 4. Similarly, the leader tile includes both T2T SPI leader 285 and T2T SPI follower 290, with only the T2T SPI leader 285 being active. As noted above, alternative non-identical manufacture is possible in which only the T2T leader is present on the leader tile and only the T2T follower is present on the follower tile.

The follower tile has its own set of PHYs 470, PCIe switch 485 and other peripherals 480. These are the same as the corresponding items shown on FIG. 2 and reference is thus made to the discussion above. PHYs 470, PCIe switch 485 and other peripherals 480 can be controlled by the CPU core 200 of the leader tile via the T2T SPI bus.

More than one bus can be present that spans both dies to provide multiple channels of communication between the dies. For example, a high-speed die-to-die SerDes-based interface as described in [Ulrich] could additionally be present. The high-speed interface described in [Ulrich] is a high bandwidth bus that enables relatively large volumes of data to be exchanged between the leader and follower tiles. Other bus types, e.g. Universal Chiplet Interconnect Express (UCIe), could additionally or alternatively be present.

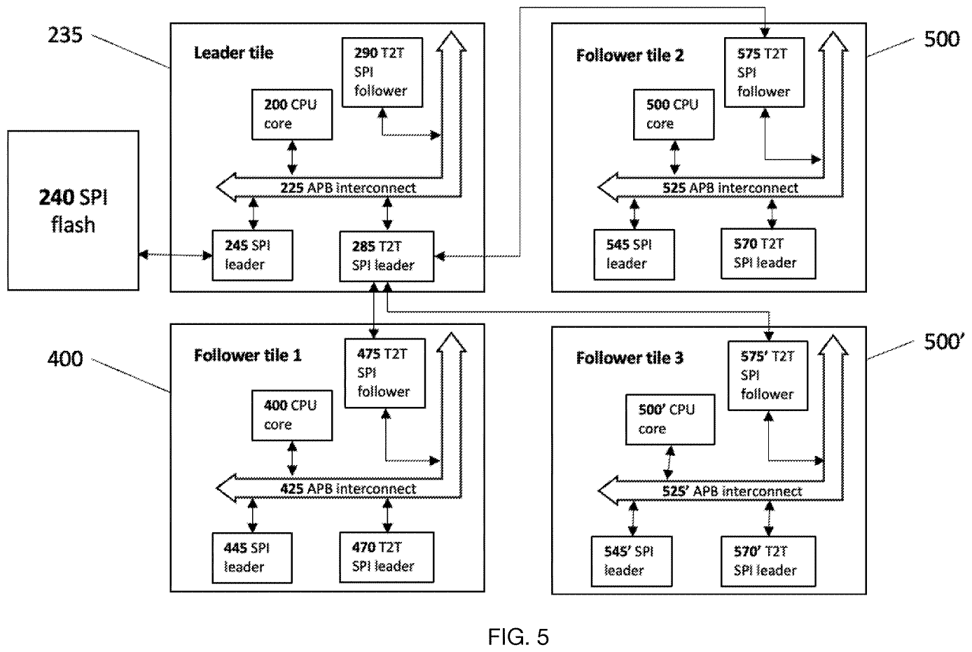

It is possible to extend the two-tile configuration discussed above to further tiles. A four-tile configuration is shown in FIG. 5. In this configuration there is one leader tile and three follower tiles (tiles 1, 2 and 3). Each of the four tiles is on its own die-leader tile is on die 235, follower tile 1 is on die 400, follower tile 2 is on die 500 and follower tile 3 is on die 500′. Each follower tile is the same as the follower tile shown in FIGS. 3 and 4 and as discussed above. The leader tile is the same as discussed above in connection with FIG. 2. T2T SPI leader 285 on the leader tile is coupled to the respective T2T SPI follower on each follower tile—i.e. T2T follower 475, 575 and 575′. This enables CPU core 200 to control any component on any of the follower tiles. Although not shown in the interests of clarity in FIG. 5, the leader tile and each follower tile has its own PHYs, PCIe switch and/or other peripherals of the type discussed above, which are all controllable by CPU core 200.

In the general case, it is possible to extend to N tiles with one leader and N-1 follower tiles each coupled to the leader tile via an inter-tile bus like the T2T SPI bus described above.

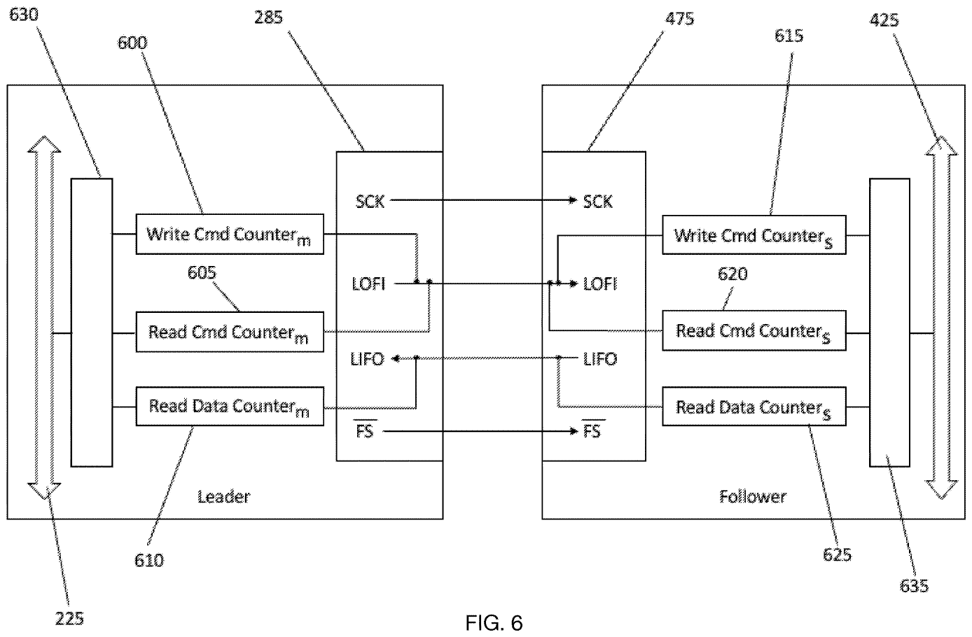

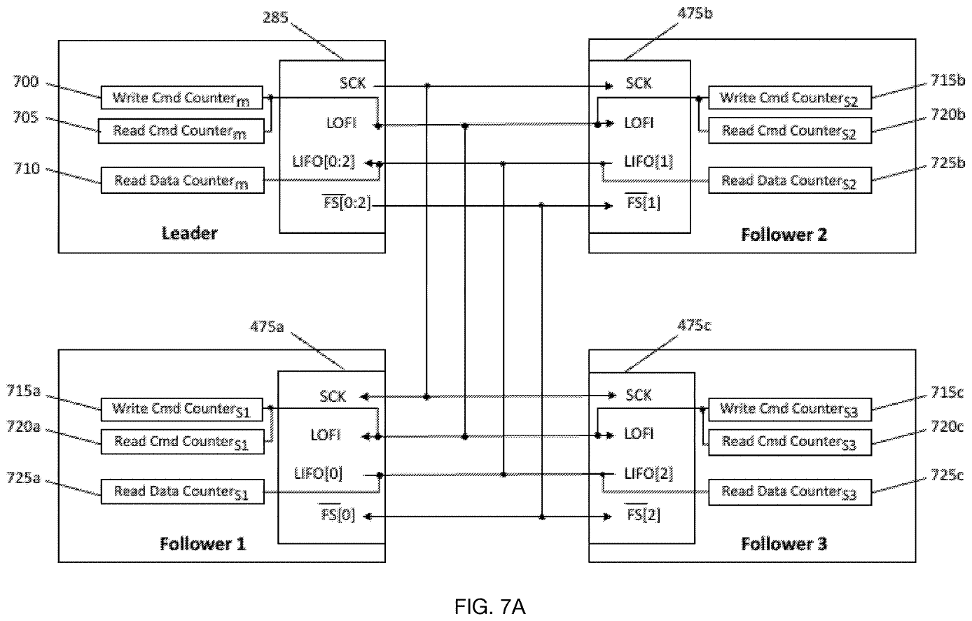

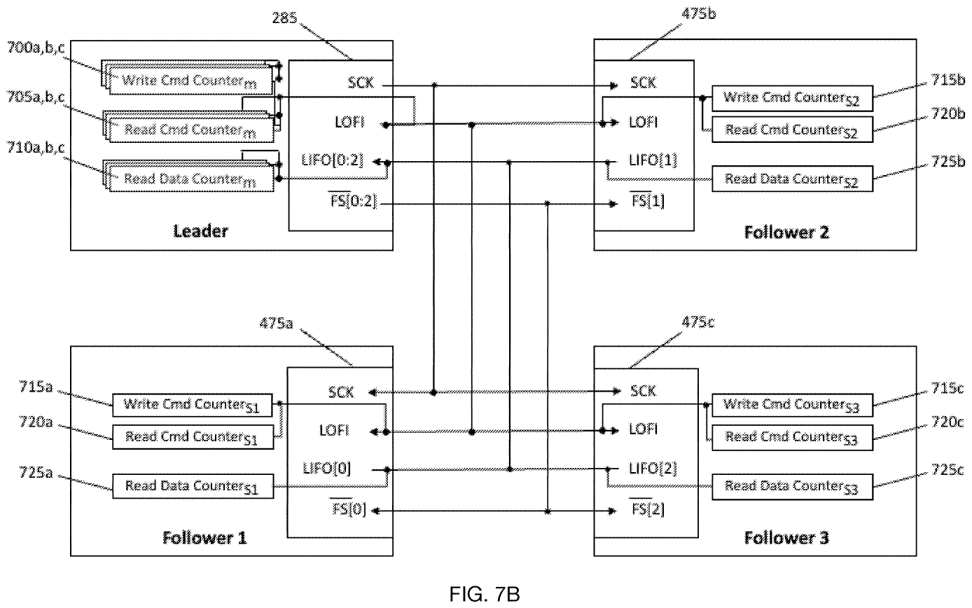

FIG. 6 provides a more detailed schematic of the configuration of the T2T SPI bus in the two-tile case. A two-tile retimer comprising a leader tile and one follower tile is shown in FIG. 6. It will be appreciated that the T2T SPI leader 285 can be coupled to additional T2T SPI bus followers in a corresponding manner—see FIGS. 7a and 7b for a four-tile retimer. These specific numbers are not limiting as the principles described herein can be extended to a N tile retimer having one leader tile and N-1 follower tiles.

The T2T SPI leader 285 includes a serial clock line SCK that carries a serial clock signal generated by T2T SPI leader 285. The SCK signal is received by all T2T SPI followers and is used to co-ordinate reading and writing of data over the T2T SPI bus.

T2T SPI leader 285 also includes a LOFI line (Leader Out Follower In) and LIFO line (Leader In Follower Out). The LOFI line is used to transmit data from the leader to the follower, i.e. as part of a write operation. The LIFO line is used to transmit data from the follower to the leader, i.e. as part of a read operation.

T2T SPI leader 285 further includes a FS line (Follower Select). This is used to signal which follower is to participate in the current operation of the bus—that is, which follower data or a command on the bus is intended for. For convenience the follower select line is shown as a single wire but in practice multiple wires can be used, one for each follower.

T2T SPI follower 475 is also coupled to all of the lines discussed above, as shown in FIG. 6, to enable two-way communication between the T2T leader and follower.

In an embodiment, also present on the leader tile is a first counter that stores a first count value. The first counter is configured to increment the first count value responsive to a first type of tile-to-tile bus event detected at a bus leader of the tile-to-tile bus.

A second counter is located on a follower tile. The second counter stores a second count value and is configured to increment the second count value responsive to the first type of tile-to-tile bus event detected at a bus follower of the tile-to-tile bus.

As the first and second counters increment in response to the same tile-to-tile bus event, at any given time the count value of the first counter should equal the count value of the second counter. The rationale here is that if the event was detected at the bus leader, the same event should also have been detected at the bus follower. An error or an attempt to hack the tile-to-tile bus, e.g. injecting commands over the tile-to-tile bus, would show up as a mismatch in count values.

FIG. 6 shows one embodiment of the above-mentioned configuration. In FIG. 6, the leader tile comprises a write command counterₘ 600, read command counterₘ 605 and read data counterₘ 610. The subscript ‘m’ indicates that these counters are associated with the leader tile. Write command counterₘ 600 and read command counterₘ 605 are both coupled to the LOFI line and read data counterₘ 610 is coupled to the LIFO line. Either write command counterₘ 600 or read command counterₘ 605 can be the ‘first counter’ referenced above.

Similarly, the follower tile includes write command counterₛ 615, read command counterₛ 620 and read data counterₛ 625. The subscript ‘s’ indicates that these counters are associated with the follower tile. Write command counterₛ 615 and read command counterₛ 620 are coupled to the LOFI line and read data counterₛ 625 is coupled to the LIFO line. Either write command counterₐ 615 or read command counterₛ 620 can be the ‘second counter’ referenced above, on the understanding that this is linked to which counter is the first counter on the leader tile. Specifically, if the first counter is write command counterₘ 600 then the second counter is write command counterₛ 615. In this case the tile-to-tile bus event would be a WRITE event, signified by a WRITE command as discussed below. Similarly, if the first counter is read command counterₘ 605 then the second counter is read command counterₛ 620. In this case the tile-to-tile bus event would be a READ event, signified by a READ command as discussed below. Complementary counters like this which are linked to a common bus event are referred to as a ‘set’ of counters.

In some embodiments multiple sets of counters are present. Each set of counters can be given a prefix, e.g. ‘first’, ‘second’, ‘third’, etc., to distinguish their identity when the nature of the counter is not known. Otherwise, where the nature of the counter is known, herein this is expressly called out—e.g. ‘read counter’, ‘write counter’. It should thus be understood that a ‘first counter’, ‘second counter’, ‘third counter’, etc. can refer to any counter described herein.

Before continuing with the discussion of these counters, it is considered useful to provide some information on SPI protocol. This is a synchronous serial communication protocol. One SPI device acts as a leader and one or more other SPI devices act as followers of the leader device. The leader device generates a clock signal and transmits the clock signal over clock line SCK that is coupled to all follower devices. The leader device transmits commands and data over a Leader Out Follower In (LOFI) line that all followers are coupled to. A follower select line is used to indicate which follower should act on commands and data currently on the LOFI line. Each follower can have a unique follower select line or a unique address on a common follower select line. When selected by the follower select line, a follower responds to leader commands. Any follower that is not currently selected ignores commands and data transmitted over the LOFI line. Followers can send data to the leader by placing data on a Leader In Follower Out (LIFO) line that all followers and the leader are coupled to. Data is transmitted in data words of a given size, e.g. 8, 12, 16, 24 or 32 bits. Elements of this protocol are referred to the in the following discussion.

An APB decoder 630 is present on the leader tile. The APB decoder 630 is coupled to APB interconnect 225 and also to each of write command counterₘ 600, read command counterₘ 605 and read data counterₘ 610. The APB decoder 630 functions to detect a read command that is sent over APB interconnect 225 and that is addressed to one of the aforementioned counters. When such a command is detected, APB decoder 630 sends the read command to the respective counter and returns a count value that is currently held by that counter to APB interconnect 225. In this way, CPU core 200 can read values stored in the counters.

It is also possible to reset counters 600, 605 and/or 610. One way this can be achieved is for CPU core 200 to issue a write command to the respective counter(s) over the APB interconnect 225. The data associated with the write command that is to be written to the respective counter(s) can be a zero value, or some other initial value (e.g. a value that each counter wraps to on overflow). The write command can be detected by APB decoder 630 and passed to the corresponding counter(s), along with the data to be written.

The follower tile has a similar setup as counters 615, 620 and 625 are also coupled to an APB decoder 635 that functions in the same way as APB decoder 630. APB decoder 630 is coupled to an APB interconnect on the follower tile (e.g. APB interconnect 425 for follower tile 1). Read and write commands can be sent by CPU core 200 via the T2T SPI interface to the APB interconnect on the follower tile to enable follower tile counter values to be read and/or one or more of the counters on the follower tile to be reset as discussed above.

Each counter on each tile can be assigned a unique address or address range in a global APB address space to enable CPU core 200 to individually address any specific counter as required.

Each of the counters can be configured to wrap on overflow so that when the maximum value is reached, the counter returns to a starting value (typically zero, but other start values such as one are also possible). Each counter can be a 32-bit counter, for example, although other sized counters are also possible.

In operation, each counter increments a count value that it stores by one (or N-1, in the case of a broadcast operation—see later for details) every time a specific type of bus event is detected. The signal type corresponding to the bus event depends on the event itself. Each type of counter and bus event is discussed in turn below. Briefly, bus events fall into three types write command events, read command events and read data events.

Each of the write command and read command events has an associated command (READ or WRITE). The command is generated by T2T SPI leader 285 and transmitted to T2T SPI follower 475 via the LOFI line. Write command counterₘ 600 and read command counterₘ 605 are each coupled to the LOFI line directly, meaning that write command counterₘ 600 and read command counterₘ 605 are each able to monitor the signals generated on the LOFI line and respectively detect signals corresponding to WRITE and READ commands. This direct coupling, i.e. a coupling that does not require an intermediary like a bus, a logic circuit, etc., means that it is relatively difficult for the count values of the write command counterₘ 600 and the read command counterₘ 605 to be tampered with, improving security.

When write command counterₘ 600 detects a WRITE command on the LOFI line, it increments its count value. Similarly, when read command counterₘ 605 detects a READ command on the LOFI line, it increments its count value. The WRITE command and READ command each have a different command code that is detectable by the respective counter. The command codes could be 8-bit command codes, for example. The read command counterₘ 605 has the capability to recognise a READ command code and to increment its count when this is detected. Similarly, the write command counterₘ 600 has the capability to recognise a WRITE command code and to increment its count when this is detected.

The same configuration is provided on the follower tile in respect of write command counterₛ 615 and read command counterₛ 620. The WRITE and READ signals on the LOFI line are respectively detected by write command counterₛ 615 and read command counterₛ 620, but in this case the signals are detected once received by T2T SPI follower 475.

Read data counterₘ 610 operates differently as it is coupled to the LIFO line which does not carry command codes. Instead, read data counterₘ 610 is configured to increment its count by one each time it detects one word of data on the LIFO line. A word size is pre-determined and known by read data counterₘ 610, e.g. 8, 16, 24 or 32 bits. These word sizes are purely exemplary and are not limiting on this disclosure as other word sizes can be used instead.

As shown, read data counterₘ 610 is coupled to the LIFO line directly, meaning that it can detect signals on the LIFO line as they are received by T2T SPI leader 285. ‘Directly’ here takes the same meaning as in the case of the other counters discussed above. One read command being issued via the LOFI line results (in normal operation) in one word of data being read via the LIFO line, meaning that in normal operation the count of read command counterₘ 605 should match the count of read data counterₘ 610.

Read data counterₛ 625 operates on the same principles as read data counterₘ 610 and thus a description of its operation is not repeated here. Read data counterₛ 625 is coupled to the LIFO line directly, meaning that it can detect signals on the LIFO line as they are generated by T2T SPI follower 625.

Write command counterₘ 600 increments on a write command bus event. This event occurs each time a write command signal is put on the LOFI line by T2T SPI leader 285. Complementary to this is write command counterₛ 615 that increments each time a write command signal is detected on the LOFI line by T2T SPI follower 565. A write command counter increments on detection of a write command signal on the part of the bus (leader or follower) that the counter is associated with, i.e. the part of the bus that is on the same tile as the counter.

In normal operation, the value of write command counterₘ 600 should be equal to the value of write command counterₛ 615 because the number of writes instructed by T2T SPI leader 285 should match the number of write instructions received by T2T SPI follower 475. A mismatch in the counter values would occur in the case where a third party has injected a write instruction, e.g. via the relatively exposed portions of the wiring of the T2T bus that are outside the tile packages. Equally, any lost or dropped write commands would be detectable as a mismatch in counter values. The write command counterₘ 600 and write command counterₛ 615 can thus be described as a ‘counter set’. Herein, a counter set refers to two or more counters that are related in some way such that they should all have the same count value at any given time in normal operation.

Read command counterₘ 605 increments on a read command bus event. This event occurs each time a read command signal is put on the LOFI line by T2T SPI leader 285. Complementary to this is read command counterₛ 620 that increments each time a read command signal is detected on the LOFI line by T2T SPI follower 565. A read command counter thus increments on detection of a read command signal on the part of the bus (leader or follower) that the counter is associated with, i.e. the part of the bus that is on the same tile as the counter.

In normal operation, the value of read command counterₘ 605 should be equal to the value of read command counterₛ 620 because the number of reads instructed by T2T SPI leader 285 should match the number of read instructions received by T2T SPI follower 475. A mismatch in the counter values would occur in the case where a third party has performed an unauthorised read operation, e.g. via the relatively exposed portions of the wiring of the T2T bus that are outside the tile packages. Equally, any lost or dropped read commands would be detectable as a mismatch in counter values. Read command counterₘ 605 and read command counterₛ 620 are therefore another example of a counter set.

Read data counterₘ 610 increments on a read data event. This occurs each time data is put on the LIFO line by T2T SPI follower 475. Complementary to this is read command counterₘ 605 that increments each time a read command is instructed by T2T SPI leader 285. A read data counter thus increments on detection of data that has been read in response to a prior read command. The data is located on the part of the bus (leader or follower) that the counter is associated with, i.e. the part of the bus that is on the same tile as the counter.

Given that in normal operation data is put onto the LIFO line in response to a read command being issued, the value of read command counterₘ 605 should be equal to the value of read data counterₘ 610. This is because the number of reads instructed by T2T SPI leader 285 should match the number of instances read data is received by T2T SPI leader 285. A mismatch in the counter values would occur in the case where a third party has injected a read instruction, e.g. via the relatively exposed portions of the wiring of the T2T bus that are outside the tile packages. Equally, any lost or dropped read commands would be detectable as a mismatch in counter values. Read data counterₘ 610 and read command counterₘ 605 are therefore a further example of a counter set.

A similar analysis can be performed in respect of each follower tile. The value of the follower tile read command counter should be equal to the value of the follower tile read data counter, for the reasons given in the paragraph directly above.

Comparison of the counts can be performed when the bus is idle to avoid a comparison taking place at a time when one counter has been incremented but the other has not due to effects like signal propagation delay or other such latencies. This is not strictly necessary as this edge case can be handled in other ways, e.g. resampling a count value after a delay in the case where a count mismatch is detected to ensure that it persists, and so implementations that perform a comparison when the bus is not idle are also possible.

FIGS. 7A and 7B show two different implementations of a multi-tile read and write counter. In each case four tiles are present—one leader and three followers. However, the techniques disclosed in connection with FIGS. 7A and 7B are not limited to this specific number of follower tiles as they have applicability in any case where there is one leader tile and two or more follower tiles.

FIG. 7A shows an implementation in which the leader tile has one write command counterₘ 700, one read command counterₘ 705 and one read data counterₘ 710, i.e. as described in connection with FIG. 6 above. Each follower tile is also the same as the follower tile described in connection with FIG. 6 above. Note that APB bus decoders like APB bus decoder 630 are also present in the embodiment of FIG. 7A. These decoders and their couplings to the various counters are not shown in FIG. 7A in the interests of clarity.

The development with respect to FIG. 6 is that the leader tile counters are configured to increment when a corresponding signal is detected in respect of any of the follower tiles. In FIG. 7A an additional subscript number has been assigned to indicate which follower tile the follower tile counter is associated with.

Thus, in FIG. 7A the write command counterₘ 700 will increment its count when a write command signal is put on the LOFI line by T2T SPI leader 285 in respect of any of the follower tiles. Similarly, the read command counterₘ 705 will increment its count when a read command signal is put on the LOFI line by T2T SPI leader 285 in respect of any of the follower tiles. Read data counterₘ 710 will increment its count when data is put on the LIFO line by any of T2T SPI followers 475a, b and c.

The value of write command counterₘ 700 should thus be equal to the sum of the values of write command counterₛ₁ 715a, write command counterₛ₂ 715b and write command counterₛ₃715c. Similarly, the value of read command counterₘ 705 should be equal to the sum of the values of read command counterₛ₁ 720a, read command counterₛ₂ 720b and read command counterₛ₃ 720c. The value of read data counterₘ 710 should be equal to the value of read command counterₘ 705. No summation is needed here because the leader tile instructs all read operations and receives all read data irrespective of the follower tile that performed the read. On each follower tile, the same is true—the value of a given follower tile's read data counter should be equal to the value of said follower tile's read command counter. Each of the combinations of counters identified above is another example of a counter set.

In some cases a broadcast operation is performed in which a read or write is instructed to multiple follower tiles simultaneously. In this case the corresponding counter on the leader tile increments by an amount equal to the number of follower tiles involved in the broadcast operation. For example, in the case of a broadcast write operation directed to all three tiles shown in FIG. 7A, write command counterₘ 700 would increment its value by three. Generally, in a N-tile system, in the case of a broadcast operation to all N-1 follower tiles the leader tile counters increment by N-1 each time a relevant signal is detected.

FIG. 7B shows an implementation in which the leader tile has multiple write command countersₘ 700a, 700b, 700c respectively corresponding to one of the follower tiles. Similarly, the leader tile has multiple read command countersₘ 705, 705b, 705c respectively corresponding to one of the follower tiles. The leader tile also has multiple read data countersₘ 710a, 710b, 710c respectively corresponding to one of the follower tiles. In the illustrated case each type of counter is present in triplicate because there are three follower tiles, but it will be appreciated that in the general case of N tiles (one leader, N-1 follower tiles) the leader tile will have N-1 of each type of counter, each counter respectively corresponding to one of the N-1 follower tiles.

Note that APB bus decoders like APB bus decoder 630 are also present in the embodiment of FIG. 7B. These decoders and their couplings to the various counters are not shown in FIG. 7B in the interests of clarity.

In addition to the couplings already discussed above, each counter on the leader tile in FIG. 7B is coupled to the follower select line FS. Monitoring the signals on the follower select line enables each counter to determine which follower tile a given command (read or write) or received data is associated with. Each leader tile counter is configured to only increment when the follower tile that it is associated with is participating in the current transaction on the T2T SPI bus (i.e. receiving a read or write command, or responding to a read command by transmitting data on the bus). In FIG. 7B an additional subscript number has been assigned to indicate which follower tile the respective counter is associated with.

Some examples are provided here to assist in the understanding of FIG. 7B. These examples form embodiments of the disclosure but are not limiting on the scope of this disclosure.

Example 1: T2T SPI leader 285 issues a write command to follower tile 2. First the follower select line signal is set such that T2T SPI follower 475b recognises that the next command is directed to follower tile 2. This is also detected by each of write command counter_{m,s2} 700b, read command counter_{m,s2} 705b and read data counter_{m,s2} 710b. These leader tile counters, which are all associated with follower tile 2, are in an active state at this point, meaning that they will respond to signals on the LOFI or LIFO line, respectively, if appropriate. The other counters on the leader tile will not respond to signals on the LOFI or LIFO lines because the follower tiles that these counters are associated with are not involved in the current bus activities.

Following the follower select line setting, a write command signal is transmitted by T2T SPI leader 285. This is detected by write command counter_{m,s2} 700b which increments by one to acknowledge the issuance of this write command. Read command counter_{m,s2} 705b and read data counter_{m,s2} 710b do not increment (despite being associated with follower tile 2) as these counters are not associated with write commands. If further write commands are issued while the follower select line remains set for follower tile 2, write command counter_{m,s2} 700b will increment responsive to these further write commands.

Example 2: Follower tile 3 transmits data over the LIFO line in response to receipt of an earlier read command. In these circumstances the follower select line is active for follower tile 3 and this is detected by the counters on the leader tile. Specifically, read data counter_{m,s3} 710c detects that follower 3 is currently selected based on the signal on the follower select line and also detects the incoming data on the LIFO line. Read data counter_{m,s3} thus increments its count in response to this detection. The other read data counters on the leader tile do not increment as the incoming data is from follower 3 only.

Example 3: T2T SPI leader 285 issues a broadcast write command—this being a write command that is to be actioned by all of followers 1, 2 and 3. The broadcast write command is issued to all of the followers simultaneously. This is detected by all of the write command counters 700a, 700b and 700c based on their monitoring of the follower select line. As the broadcast write command is actioned by all followers, all of the write command counters 700a, 700b and 700c increment their respective counters in response to detection of the broadcast write command.

In normal operation of FIG. 7B it is expected that the value of each leader tile write command counter 700a, 700b, 700c will respectively match the value of the write command counter 715a, 715b, 715c on the corresponding follower tile. Similarly, in normal operation it is expected that the value of each leader tile read command counter 705a, 705b, 705c will respectively match the value of the read command counter 720a, 720b, 720c on the corresponding follower tile. Further, in normal operation it is expected that the value of each leader tile read data counter 710a, 710b, 710c will match the value of the respective leader tile read command counter 705a, 705b, 705c. Each of these combinations of corresponding counters is a counter set.

As noted earlier, a discrepancy in the count value within any of these sets of counters could indicate a security issue or an operational issue that is causing read and/or write commands to be dropped. Advantageously, it is possible in the case of FIG. 7B to identify which follower tile(s) is/are affected based on which pair(s) of counter(s) has/have different count values. This allows for focused remediation efforts and/or to provide more detailed error reporting capabilities, and the like.

It will be appreciated that the read and write counter technique disclosed herein is not restricted to SPI buses. This technique can be extended to any type of bus, where modifications may be necessary to take account of the specifics of the bus. For example, in the case of an I²C bus, the read and write counters can be implemented as counters operating in a snoop mode in which address information and read/write bit values are collected to determine whether a given instruction is a read or write instruction and also to determine the recipient of the instruction.

The count values of the various sets of counters can be checked in what is referred to herein as a ‘coherency check’. A coherency check can be performed by CPU core 200. A coherency check generates a coherency value by reading the value of each counter in a set and checking that these values correspond to one another as described in detail above. The coherency value could take one value (e.g. ‘0’) in the case that the counter values correspond to one another. The coherency value could take another value (e.g. ‘1’) in the case that the counter values do not correspond to one another. These values are purely exemplary and should not be construed as limiting this disclosure. Multi-bit coherency values are also possible, e.g. to enable the comparison between each pair of counters in a set to be captured in the coherency value. Alternatively, a set of coherency values can be determined, each coherency value in the set corresponding to one of the pairs of counters.

CPU core 200 is configured to determine a coherency status in response to the coherency value. The coherency status could be security-related, e.g. ‘secure’ or ‘not secure’. Alternatively, the coherency status could be an operational status indicative of whether any dropped commands have occurred, e.g. ‘normal operation’ or ‘error(s) detected’. These statuses could be represented by particular values, e.g. 0=‘secure’, 1=‘not secure’ or 0=‘normal operation’, 1=‘error(s) detected’. The status of ‘secure’ or ‘normal operation’ corresponds to the case where the counter values do correspond to one another. The status of ‘not secure’ or ‘error(s) detected’ corresponds to the case where the counter values do not correspond to one another. This is purely exemplary and other values including multi-bit values could be used instead. A multi-bit value allows more than two statuses to be set, enabling a sliding scale of severity to be defined with more severe statuses being assigned in the case of a greater discrepancy between counter values.

In the case of a security-related coherency status, a coherency status of ‘secure’ warrants no action from CPU core 200. Thus, in one embodiment, CPU core 200 takes no action in the case where the coherency value corresponds to a coherency status of ‘secure’. In the case where the coherency value corresponds to a coherency status of ‘not secure’, CPU core 200 takes remedial action. Further details on possible remedial actions are provided later in this specification.

In the case of an operationally-related coherency status, a coherency status of ‘normal operation’ warrants no action from CPU core 200. Thus, in one embodiment, CPU core 200 takes no action in the case where the coherency value corresponds to a coherency status of ‘normal operation’. In the case of a coherency value of ‘error(s) detected’, CPU core 200 takes remedial action as described later in this specification.

The coherency check can be performed on a schedule by CPU core 200, e.g. once every time a certain amount of time has passed. The coherency check can additionally or alternatively be performed after a certain number of operations have occurred. This could be a cumulative total of all types of operation (i.e. read, write and data return) or it could be that an operation-specific coherency check is performed after a certain number of operations of that type have been performed (e.g. after X write operations have occurred, the coherency of the write command counters is checked). In either case, an ‘unscheduled’ coherency check can be performed at any time, i.e. outside of the scheduled coherency checks. An unscheduled coherency check can be performed by CPU 200 based on an instruction received from e.g. a host CPU, or via a debug interface (e.g. a JTAG interface). Other triggers for initiating a coherency check are possible.

Scheduling of coherency checks can be set according to information contained in the firmware of CPU core 200, for example.

In the case where the coherency check reveals that there is a counter mismatch, i.e. one of the counters does not have the value it is expected to have, the coherency status is set to an error state to indicate that there is an issue. The coherency status could take the form of a flag that could be stored in data RAM 215, for example. The security status flag can store the coherency value discussed above. Additional information can be provided to accompany the security stats flag (e.g. stored in data RAM 215), such as an identifier of the tile(s) and/or counter(s) affected by the issue. The security status flag can be assigned a particular memory address or range of addresses that are associated with a vendor-defined region of SMBus 265. An equivalent flag can be used in the case of an operational status, i.e. an operational status flag.

In the case where the coherency value indicates an insecure/error state, remedial action can be taken. The remedial action can be any combination of halting operation of CPU core 200, operating CPU core 200 in a reduced operation (‘secure’) mode, instructing the T2T SPI bus to cease operating, clearing (or otherwise overwriting) one or more registers and/or memories on the leader tile and/or follower tiles, requesting a re-send of an instruction to the T2T SPI bus, re-sending an instruction by the SPI leader 285, re-sending data as part of a read command response by a SPI follower, resetting the retimer, and the like. An interrupt request may be raised for a host CPU that is external to the multi-chip module to handle. In the case of a reset, a scratchpad register (not shown), or a data RAM of the CPU core 200, or other such memory that retains information during a reset, can be written to in order to provide information about the coherency state of the retimer at the time the reset was performed.

The mismatch can be deemed minor or major. A minor mismatch does not warrant any action, or warrants a relatively minor action, whereas a major mismatch requires a corresponding major response, e.g. halting operation of CPU core or switching operation to a secure mode. A minor mismatch is typically more suggestive of a transient error whereas a major mismatch is suggestive of a more serious operational issue or a security breach.

A threshold can be defined for the maximum allowable discrepancy between counters in a set that is classed as minor. A discrepancy that is greater than or equal to the threshold can be classed as major. For example, a discrepancy in value of three or less could be classed as a minor discrepancy, but a discrepancy of four or more could be classed as a major discrepancy. These values are purely exemplary and should not be understood as limiting.

The number of counter sets that are simultaneously showing a discrepancy can also be taken into account when deciding whether a discrepancy is minor or major. If just one set of counters is showing a discrepancy, this could lead to the discrepancy being classified as minor. However, if two or three sets of counters are each showing a discrepancy, this could lead to the discrepancy being classified as major.

A score can be produced based on the magnitude of the discrepancy and the number of counter sets currently showing a discrepancy, where the score increases with increasing discrepancy and increasing numbers of counter sets being discrepant. Scores greater than or equal to a threshold value can be considered high enough to cause remedial action to be taken.

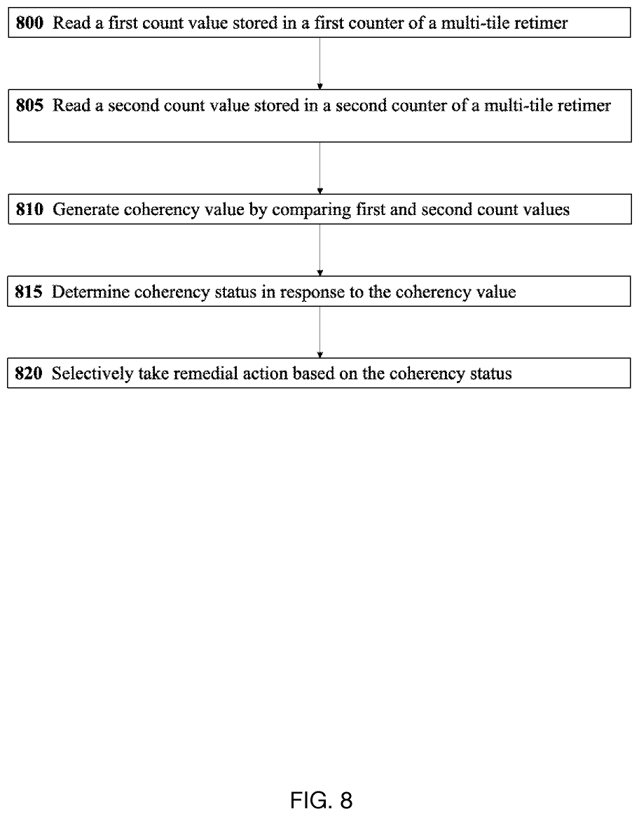

FIG. 8 sets out a flowchart for a method that can be performed by a multi-tile retimer of the type described above. Step 800 comprises reading a first count value stored in a first counter of a multi-tile retimer. The first counter is located on a leader tile of the multi-tile retimer. The first counter is configured to be incremented responsive to a first type of tile-to-tile bus event detected at a bus leader of a tile-to-tile bus coupled between the leader tile of the multi-tile retimer and a follower tile of the multi-tile retimer. The first counter can be a read data counter or a write command counter as discussed above. The T2T bus can be the T2T SPI bus discussed above, and the bus leader can be T2T SPI leader 285. The type of T2T bus event can be a read command or a write command, as discussed above. The multi-tile retimer can be the two-tile retimer or the four-tile retimer discussed above. Other tile numbers are also possible. The first and second counters can be members of a counter set.

Step 805 comprises reading a second count value stored in a second counter of the multi-tile retimer. The second counter is located on a follower tile of the multi-tile retimer and is configured to be incremented responsive to the first type of tile-to-tile bus event detected at a bus follower of the tile-to-tile bus. The second counter can be a read counter or a write counter as discussed above and the bus follower can be SPI follower 475.

Step 810 comprises generating a coherency value by comparing the first count value and the second count value. The coherency value can be set based on whether the comparison reveals that the first count value is equal to the second count value, less than the second count value, or greater than the second count value. In the case where the first and second count values are not equal, the comparison can include calculating the difference between the first and second count values. Reference is also made to the discussion above regarding coherency checks and coherency values.

Step 815 comprises determining a coherency status in response to the coherency value. The coherency status can be any of the statuses discussed above.

Step 820 comprises selectively taking remedial action based on the coherency status. Remedial action is taken in the case where the coherency status suggests that there is a security issue and/or an operational issue. Where the coherency status suggests that no issue is present, no action is taken. As discussed above, a security issue could take the form of an unauthorised party injecting commands onto the T2T bus via the relatively exposed portions of the wires that are located between the leader tile and follower tile. An operational issue could take the form of the T2T bus follower dropping commands, or not responding to commands from the T2T bus leader correctly. Whether remedial action is taken can depend on various factors including any one or more of: the magnitude of a difference between the first and second count values, whether the magnitude of the difference is greater than or equal to a threshold value, the number of counter sets that simultaneously have a difference in their respective count values, and the like. The remedial action itself is discussed above and reference is made here to that discussion.

The method of FIG. 8 can be performed by CPU core 200. Some elements, e.g., steps 800, 805 810 and 815 could be performed in hardware, with the result of the comparison being forwarded to CPU core 200 for a decision on whether to take remedial action (step 820). Irrespective of how it is executed, the method of FIG. 8 can be performed on a schedule as discussed above.

It can be possible to reset the value of any of the counters discussed above. This can occur following a particular event, e.g. a change in a security level of the multi-tile retimer. A global reset can set all counters on all tiles of the multi-tile retimer to zero (or another start value). It is also possible to provide a ‘counter set reset’ capability in which a specific set of counters are reset, e.g. perhaps following detection and resolution of an issue associated with that set of counters. A reset can be triggered by the processor/CPU core 200, for example.

It is also contemplated that the first and second counters could reside on the same tile, e.g. leader tile 235. In this case the first counter is read command counterₘ 605 and the second counter is read data counterₘ 610. Here the bus event associated with each counter is different but the events are associated with one another. This association is specifically the relationship that issuance of a read command by the bus leader should result in data being received over the LIFO line by the bus leader. A coherency value can be generated by comparing the count value of the read command counterₘ 605 with the count value of the read data counterₘ 610. As discussed above, a discrepancy in the count value could indicate an operational error or security issue.

In this embodiment, a method comprises: reading a first count value stored in a first counter of a multi-tile retimer, the first counter configured to be incremented responsive to a first type of tile-to-tile bus event of a tile-to-tile bus coupled between a leader tile of the multi-tile retimer and a follower tile of the multi-tile retimer; reading a second count value stored in a second counter of the multi-tile retimer, the second counter configured to be incremented responsive to a second type of tile-to-tile bus event of the tile-to-tile bus, the first type of tile-to-tile bus event and the second type of tile-to-tile bus event being associated with one another; generating a coherency value by comparing the first count value and the second count value; determining a coherency status in response to the coherency value; and selectively taking remedial action based on the coherency status.

This method can be carried out by a multi-tile retimer comprising: a first counter configured to increment a first count value stored by the first counter responsive to a first type of tile-to-tile bus event of a tile-to-tile bus coupled between the leader tile and a follower tile of the multi-tile retimer; a second counter configured to increment a second count value stored by the second counter responsive to a second type of tile-to-tile bus event of the tile-to-tile bus, the first type of tile-to-tile bus event and the second type of tile-to-tile bus event being associated with one another; and a central processing unit located on the leader tile and configured to: generate a coherency value by comparing the first count value and the second count value; determine a coherency status based on the coherency value; and selectively take remedial action based on the coherency status.

While the above description has been provided in the context of a multi-tile retimer, it will be appreciated that the principles established herein can be applied more generally to any multi-chip module performing any function, e.g. input/output functions. In such a multi-chip module (MCM), transactions that enable communication between tiles, e.g. via a tile-to-tile bus or equivalent interface, can be counted in the manner set out above in order to enable a coherency check to be carried out.

In addition to the embodiments described above, the following clauses represent additional embodiments of this disclosure.

Clause 1: A method, comprising: reading a first count value stored in a first counter of a multi-tile retimer, the first counter located on a leader tile of the multi-tile retimer and configured to be incremented responsive to a first type of tile-to-tile bus event detected at a bus leader of a tile-to-tile bus coupled between the leader tile of the multi-tile retimer and a follower tile of the multi-tile retimer; reading a second count value stored in a second counter of the multi-tile retimer, the second counter located on a follower tile of the multi-tile retimer and configured to be incremented responsive to the first type of tile-to-tile bus event detected at a bus follower of the tile-to-tile bus; generating a coherency value by comparing the first count value and the second count value; determining a coherency status in response to the coherency value; and selectively taking remedial action based on the coherency status.

Clause 2: The method of clause 1, wherein the first counter is a write command counter, the first type of tile-to-tile bus event is a write command and the second counter is a write command counter.

Clause 3: The method of clause 1, wherein the first counter is a read command counter, the first type of tile-to-tile bus event is a read command, and the second counter is a read command counter Clause 4: The method of clause 3, further comprising: reading a third count value stored in a read data counter located on the leader tile, the read data counter configured to be incremented responsive to receipt of read data on the bus leader; wherein generating the coherency value further comprises comparing the first count value and the third count value.

Clause 5: The method of clause 2, further comprising: reading a third count value stored in a read command counter located on the leader tile, the read command counter configured to be incremented responsive to a read command on the bus leader; and reading a fourth count value stored in a read command counter located on the follower tile, the read command counter configured to be incremented responsive to a read command on the bus follower; wherein generating the coherency value further comprises comparing the third count value and the fourth count value.

Clause 6: The method of clause 2, further comprising: reading a third count value stored in a read command counter located on the leader tile, the read command counter configured to be incremented responsive to a read command on the bus leader; and reading a fourth count value stored in a read data counter located on the leader tile, the read data counter configured to be incremented responsive to receipt of read data on the bus leader; wherein generating the coherency value further comprises comparing the third count value and the fourth count value.

Clause 7: The method of clause 6, further comprising: reading a fifth count value stored in a read command counter located on the follower tile, the read command counter configured to be incremented responsive to a read command on the bus follower; and wherein generating the coherency value further comprises comparing the third count value and the fifth count value.

Clause 8: The method of any preceding clause, wherein selectively taking remedial action based on the coherency status further comprises determining whether the compared count values are equal or not and taking remedial action in the case where the compared count values are not equal.

Clause 9: The method of any preceding clause, wherein the remedial action comprises ceasing a retiming function of the multi-tile retimer.

Clause 10: The method of any preceding clause, wherein the remedial action comprises raising an interrupt to a host processor communicatively coupled to the multi-tile retimer.

Clause 11: A multi-tile retimer, comprising: a first counter located on a leader tile of the multi-tile retimer and coupled to a bus leader of a tile-to-tile bus located on the leader tile, the first counter configured to increment a first count value stored by the first counter responsive to a first type of tile-to-tile bus event of the tile-to-tile bus detected at the bus leader, the tile-to-tile bus coupled between the leader tile and a follower tile of the multi-tile retimer; a second counter located on the follower tile and coupled to a bus follower of the tile-to-tile bus, the second counter configured to increment a second count value stored by the second counter responsive to the first type of tile-to-tile bus event of the tile-to-tile bus detected at the bus follower; and a central processing unit located on the leader tile and configured to: generate a coherency value by comparing the first count value and the second count value; determine a coherency status based on the coherency value; and selectively take remedial action based on the coherency status.

Clause 12: The multi-tile retimer of clause 11, wherein the first counter is a write command counter, the first type of tile-to-tile bus event is a write command, and the second counter is a write command counter.

Clause 13: The multi-tile retimer of clause 11, wherein the first counter is a read command counter, the first type of tile-to-tile bus event is a read command, the second counter is a read command counter.

Clause 14: The multi-tile retimer of clause 13, further comprising: a read data counter located on the leader tile, the read data counter configured to increment a third count value stored by the read data counter responsive to receipt of read data on the bus leader; wherein the central processing unit is further configured to generate the coherency value by comparing the first count value and the third count value.

Clause 15: The multi-tile retimer of clause 12, further comprising: a read command counter located on the leader tile, the read command counter configured to increment a third count value stored by the read command counter in response to a read command on the bus leader; and a read command counter located on the follower tile, the read command counter configured to increment a fourth count value stored by the read command counter in response to a read command on the bus follower; wherein the central processing unit is further configured to generate the coherency value by comparing the third count value and the fourth count value.

Clause 16: The multi-tile retimer of clause 12, further comprising: a read command counter located on the leader tile, the read command counter configured to increment a third count value stored by the read command counter responsive to receipt of a read command on the bus leader; and a read data counter located on the leader tile, the read data counter configured to increment a fourth count value stored by the read data counter responsive to receipt of read data on the bus leader; wherein the central processing unit is further configured to generate the coherency value by comparing the third count value and the fourth count value.

Clause 17: The multi-tile retimer of clause 16, further comprising: a read command counter located on the follower tile, the read command counter configured to increment a fifth count value stored by the read command counter responsive to a read command on the bus follower; wherein the central processing unit is further configured to generate the coherency value by comparing the third count value and the fifth count value.

Clause 18: The multi-tile retimer of any one of clauses 11 to 17, wherein: the tile-to-tile bus is a Serial Peripheral Interface (SPI) bus; the first counter is coupled to a Leader Out Follower In (LOFI) line of the tile-to-tile bus; and the second counter is coupled to the LOFI line of the tile-to-tile bus.

Clause 19: The multi-tile retimer of clause 18, wherein: the first counter is configured to detect a command code on the LOFI line and to increment the first count value responsive to detection of the command code; and the second counter is configured to detect the command code on the LOFI line and to increment the second count value responsive to detection of the command code.

Clause 20: The multi-tile retimer of clause 18 or clause 19, wherein the central processing unit is coupled to each of the first counter and the second counter via a data bus.

It will be apparent to a person skilled in the art having the benefit of the present disclosure that various modifications, extensions, substitutions and the like to the subject matter described herein are possible. Such changes are also within the scope of this disclosure. It is also noted that, where method steps are described, these steps can be performed in any order unless expressly stated otherwise.

1. A method, comprising:
reading a first count value stored in a first counter of a multi-tile retimer, the first counter located on a leader tile of the multi-tile retimer and configured to be incremented responsive to a first type of tile-to-tile bus event detected at a bus leader of a tile-to-tile bus coupled between the leader tile of the multi-tile retimer and a follower tile of the multi-tile retimer;
reading a second count value stored in a second counter of the multi-tile retimer, the second counter located on a follower tile of the multi-tile retimer and configured to be incremented responsive to the first type of tile-to-tile bus event detected at a bus follower of the tile-to-tile bus;
generating a coherency value by comparing the first count value and the second count value;
determining a coherency status in response to the coherency value; and
selectively taking remedial action based on the coherency status.

2. The method of claim 1, wherein the first counter is a write command counter, the first type of tile-to-tile bus event is a write command and the second counter is a write command counter.

3. The method of claim 1, wherein the first counter is a read command counter, the first type of tile-to-tile bus event is a read command, and the second counter is a read command counter.

4. The method of claim 3, further comprising:
reading a third count value stored in a read data counter located on the leader tile, the read data counter configured to be incremented responsive to receipt of read data on the bus leader;
wherein generating the coherency value further comprises comparing the first count value and the third count value.

5. The method of claim 2, further comprising:
reading a third count value stored in a read command counter located on the leader tile, the read command counter configured to be incremented responsive to a read command on the bus leader; and
reading a fourth count value stored in a read command counter located on the follower tile, the read command counter configured to be incremented responsive to a read command on the bus follower;
wherein generating the coherency value further comprises comparing the third count value and the fourth count value.

6. The method of claim 2, further comprising:
reading a third count value stored in a read command counter located on the leader tile, the read command counter configured to be incremented responsive to a read command on the bus leader; and
reading a fourth count value stored in a read data counter located on the leader tile, the read data counter configured to be incremented responsive to receipt of read data on the bus leader;
wherein generating the coherency value further comprises comparing the third count value and the fourth count value.

7. The method of claim 6, further comprising:
reading a fifth count value stored in a read command counter located on the follower tile, the read command counter configured to be incremented responsive to a read command on the bus follower; and
wherein generating the coherency value further comprises comparing the third count value and the fifth count value.

8. The method of claim 1, wherein selectively taking remedial action based on the coherency status further comprises determining whether the compared count values are equal or not and taking remedial action in the case where the compared count values are not equal.

9. The method of claim 1, wherein the remedial action comprises ceasing a retiming function of the multi-tile retimer.

10. The method of claim 1, wherein the remedial action comprises raising an interrupt to a host processor communicatively coupled to the multi-tile retimer.

11. A multi-tile retimer, comprising:
a first counter located on a leader tile of the multi-tile retimer and coupled to a bus leader of a tile-to-tile bus located on the leader tile, the first counter configured to increment a first count value stored by the first counter responsive to a first type of tile-to-tile bus event of the tile-to-tile bus detected at the bus leader, the tile-to-tile bus coupled between the leader tile and a follower tile of the multi-tile retimer;
a second counter located on the follower tile and coupled to a bus follower of the tile-to-tile bus, the second counter configured to increment a second count value stored by the second counter responsive to the first type of tile-to-tile bus event of the tile-to-tile bus detected at the bus follower; and
a central processing unit located on the leader tile and configured to: generate a coherency value by comparing the first count value and the second count value; determine a coherency status based on the coherency value; and selectively take remedial action based on the coherency status.

12. The multi-tile retimer of claim 11, wherein the first counter is a write command counter, the first type of tile-to-tile bus event is a write command, and the second counter is a write command counter.

13. The multi-tile retimer of claim 11, wherein the first counter is a read command counter, the first type of tile-to-tile bus event is a read command, the second counter is a read command counter.

14. The multi-tile retimer of claim 13, further comprising:
a read data counter located on the leader tile, the read data counter configured to increment a third count value stored by the read data counter responsive to receipt of read data on the bus leader;
wherein the central processing unit is further configured to generate the coherency value by comparing the first count value and the third count value.

15. The multi-tile retimer of claim 12, further comprising:
a read command counter located on the leader tile, the read command counter configured to increment a third count value stored by the read command counter in response to a read command on the bus leader; and
a read command counter located on the follower tile, the read command counter configured to increment a fourth count value stored by the read command counter in response to a read command on the bus follower;
wherein the central processing unit is further configured to generate the coherency value by comparing the third count value and the fourth count value.

16. The multi-tile retimer of claim 12, further comprising:
a read command counter located on the leader tile, the read command counter configured to increment a third count value stored by the read command counter responsive to receipt of a read command on the bus leader; and
a read data counter located on the leader tile, the read data counter configured to increment a fourth count value stored by the read data counter responsive to receipt of read data on the bus leader;
wherein the central processing unit is further configured to generate the coherency value by comparing the third count value and the fourth count value.

17. The multi-tile retimer of claim 16, further comprising:
a read command counter located on the follower tile, the read command counter configured to increment a fifth count value stored by the read command counter responsive to a read command on the bus follower;
wherein the central processing unit is further configured to generate the coherency value by comparing the third count value and the fifth count value.

18. The multi-tile retimer of claim 11, wherein:
the tile-to-tile bus is a Serial Peripheral Interface (SPI) bus;
the first counter is coupled to a Leader Out Follower In (LOFI) line of the tile-to-tile bus; and
the second counter is coupled to the LOFI line of the tile-to-tile bus.

19. The multi-tile retimer of claim 18, wherein:
the first counter is configured to detect a command code on the LOFI line and to increment the first count value responsive to detection of the command code; and
the second counter is configured to detect the command code on the LOFI line and to increment the second count value responsive to detection of the command code.

20. The multi-tile retimer of claim 18, wherein the central processing unit is coupled to each of the first counter and the second counter via a data bus.
